(19) United States
(12) Patent Application Publication
(10) Pub. No.: US 2002/0175059 A1
(43) Pub. Date: Nov. 28, 2002

(54) Receptacle with contact points for switch

(76) Inventor: Chyong-Yen Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/862,331

(22) Filed: May 23, 2001

(51) Int. Cl. H01R 13/70

(52) U.S. Cl. 200/51 R

(57) ABSTRACT

A receptacle with contact points for switch comprises a single-molded base to receive a receptacle with a few conducting metal plates formed into a loop mounting therein. Each conducting metal plate has a portion extending outwardly as connecting point with a plug, and as contact point with respect to a control circuit of the switch. That allows a switch device to be mounted in a various manner, each conducting plate is connected with each other, a switch device is attached to each conducting plate, or to all conducting plates.

### BACKGROUND OF THE INVENTION

1. Field of the Invention

This invention relates to a receptacle, and more particularly to a single-molded base to receive a receptacle with a few conducting metal plates formed into a loop mounting therein.

2. Description of the Related Prior Art

Conventional extension cords are mostly in multi receptacles, and each receptacle has a separated control switch, a light, or a protective device. The switch controls the conductivity of the plug hole, the light indicates the plug hole is turned on or off, while the protective device is to protect the receptacle not to overload. The wall receptacles of prior arts are also molded with a single separated plug hole.

All of the above mentioned prior arts are in separates switch control and has a positive and negative connection within the receptacle. However, this design has many confinements, one of which is that he switches and plug holes require a bigger space, further, the design is restrained by its mold which is not easy to change the outfit.

In view of these shortcomings and others, the inventor has invented the present invention to overcome the shortcomings.

### SUMMARY OF THE INVENTION

It is the primary object of the present invention to provide a receptacle with contact points for switch, which has a various attractive outfit.

It is another object of the present invention to provide a receptacle with contact points for switch, which is compact in size.

### BRIEF DESCRIPTION OF THE DRAWINGS

FIG. 1 is an exploded view of the present invention

FIG. 2 is a perspective view of a single mold of the present invention;

FIG. 3 is an exploded view composed with other devices of the present invention;

FIG. 4 is a perspective view of a single molded receptacle;

FIG. 5 is a perspective view of a series single molded receptacle;

FIG. 6 is another perspective view showing a second embodiment of a series single molded receptacle;

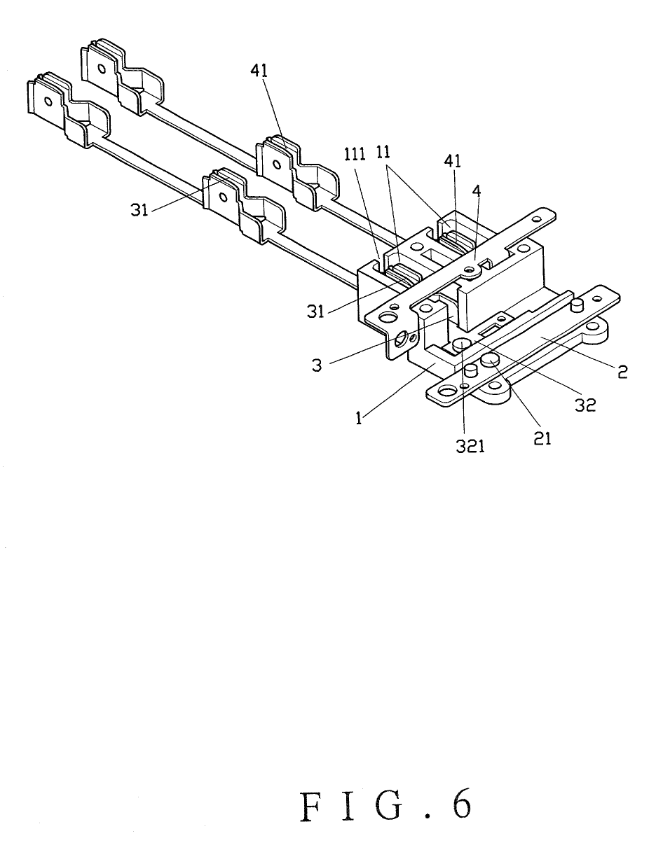

FIG. 7 is a perspective view of a single molded receptacle with a case;

FIG. 8 is an exploded view of a single receptacle of another embodiment having installed with other devices;

FIG. 9 is a partial assembled perspective view of FIG. 8; and

FIG. 10 is a perspective view of the second embodiment.

### DETAILED DESCRIPTION OF THE PREFERRED EMBODIMENTS

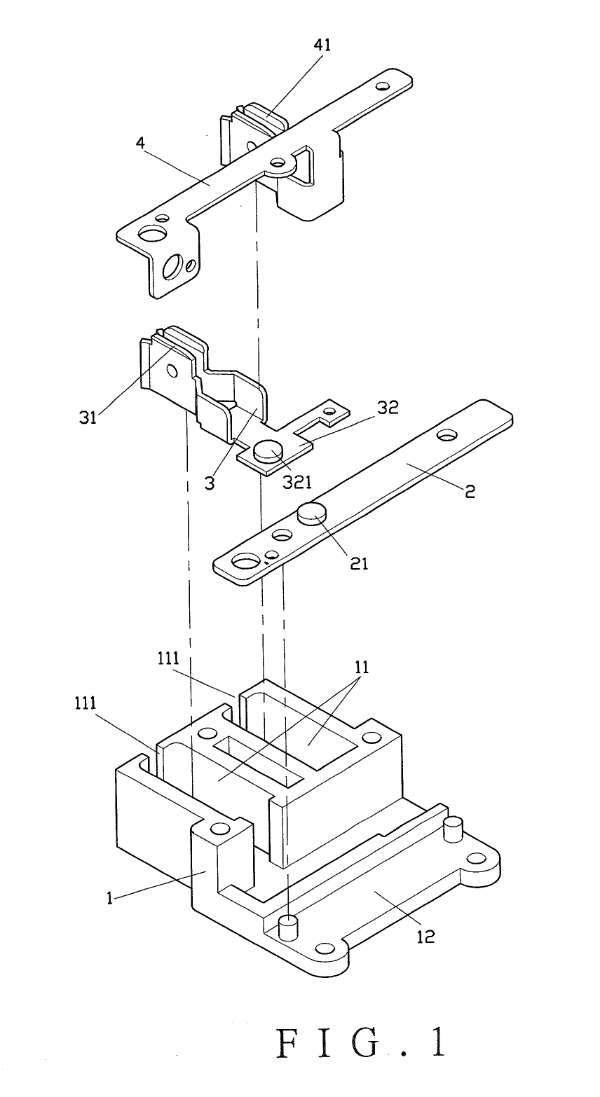

The receptacle with contact points for switch, as shown in FIG. 1, comprises a base 1 for a first conducting plate 2, a second conducting plate 3 and a third conducting plate 4 to be mounted therein.

The base 1 has a trough 11 with two sections therein, the trough 11 has grooves 111 (or open space) at one side corresponding to a slot 31 of the second conducting plate 3 and a slot 41 of the third conducting plate 4. The other side of the trough 11 extends a bridge 12.

The first conducting plate 2 is a longitudinal plate having a contact point 21 thereon, and is seating on the bridge 12.

The second conducting plate 3 comprises a slot 31 which is seating in one of the sections of the trough 11. The slot 31 is designed to allow insertion from various directions, and extends a contact end 32 which has a contact point 321 corresponding to the contact point 21 of the first conducting plate 2.

The third conducting plate 4 has a slot 41 corresponding to another section of the trough 11 and is also available for insertion from various directions.

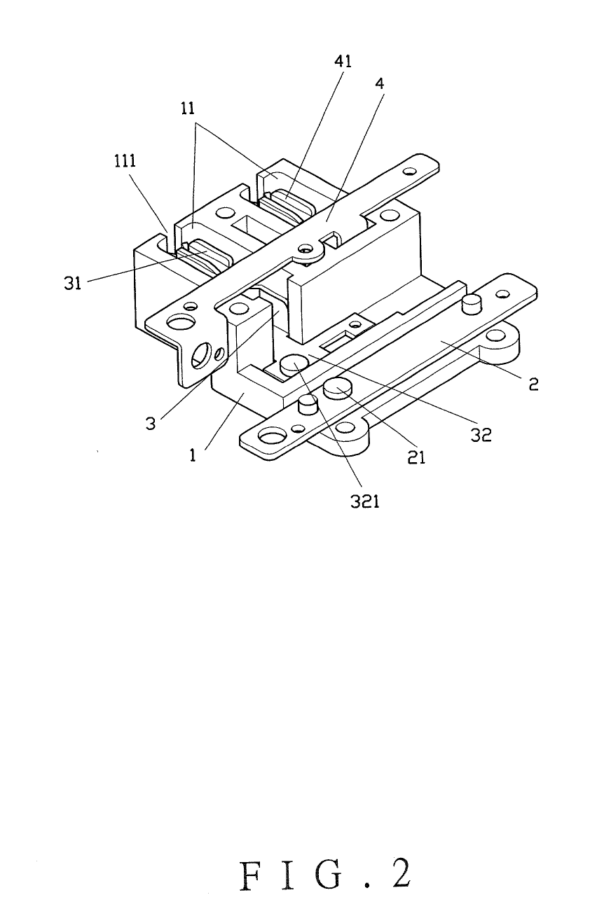

Upon assembled, the two sections of the trough 11 of the base 1 are for the two slots 31 and 41 to seat therein, as shown in FIG. 2. Wherein, the contact point 321 of the contact end 32 is adjacent to the contact point 21 of the first conducting plate 2, but not contact together. This forms a single receptacle and which may be used as an extension cord or a wall mount receptacle. Due to the special design of the contact point 21 and the contact point 321, switching device may be mounted in various manners.

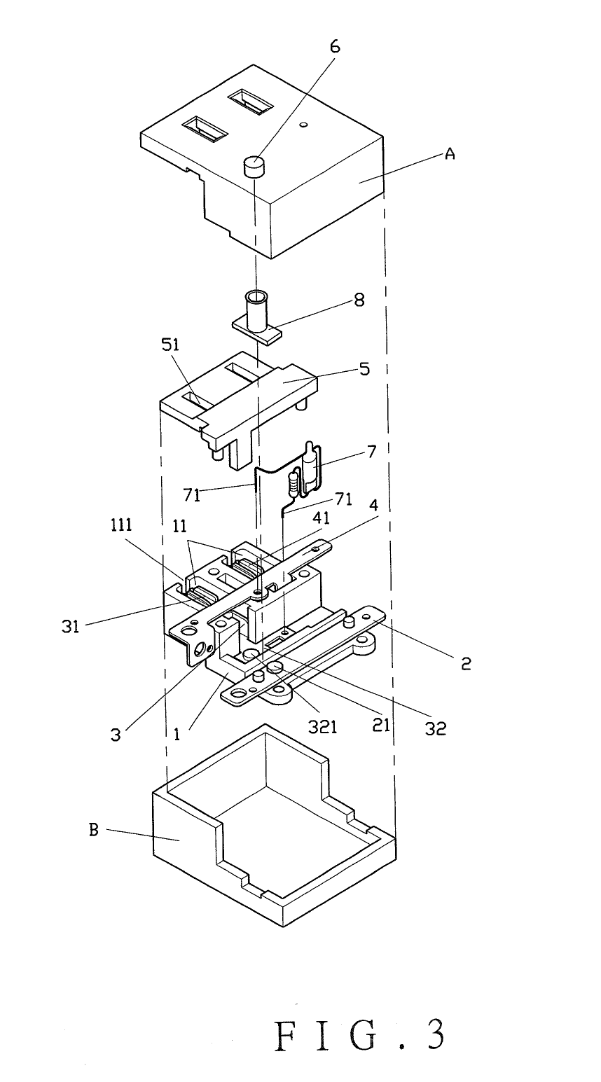

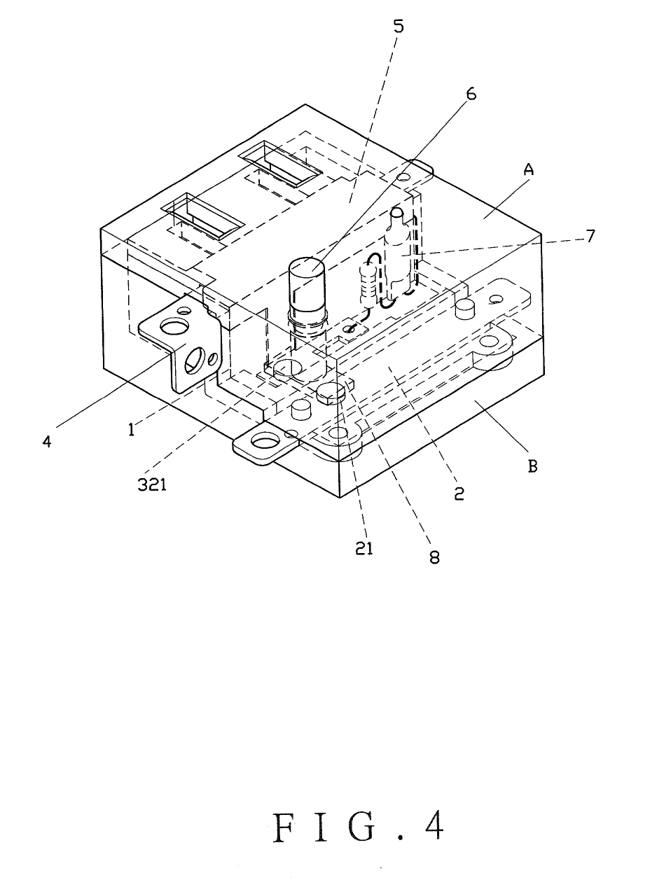

When installed with other devices, the receptacle will require a cover 5, a switch device 6, a light indicator 7 and an upper shell A and a lower shell B, as shown in FIGS. 3 and 4. The cover 5 is placed onto the base 1 with holes 51 (or open space) corresponding to the slots 31 and 41 of the second conducting plate 3 and the third conducting plate 4 in the trough 11. A conducting part 8 is formed in between the contact point 321 of the contact end 32 extending from the second conducting plate 3 and the contact point 21 of the first conducting plate 2 as a switch to the circuit. This conducting part 8 is linked with the switch device 6. The switch device 6 can be various designs. The light indicator 7 has its two feet 71 connected with the second conducting plate 3 and the third conducting plate 4, respectively. Thus, when the circuit turns on, the light turns on, simultaneously. The light indicator 7 has neither fixed shape nor fixed place in the receptacle. It is shaped in according to the design of the upper shell A and the lower shell B, so long as its two feet 71 are able to reach and in connection with the second conducting plate 3 and the third conducting plate 4.

The base 1 receives the first conducting plate 2, the second conducting plate 3, the third conducting plate 4, and other devices to form the switch unit, which may be used as an extension cord, or a wall receptacle. The single mold may be slid into with a series of single receptacles. There are two ways to form the single extension cord, and they are:

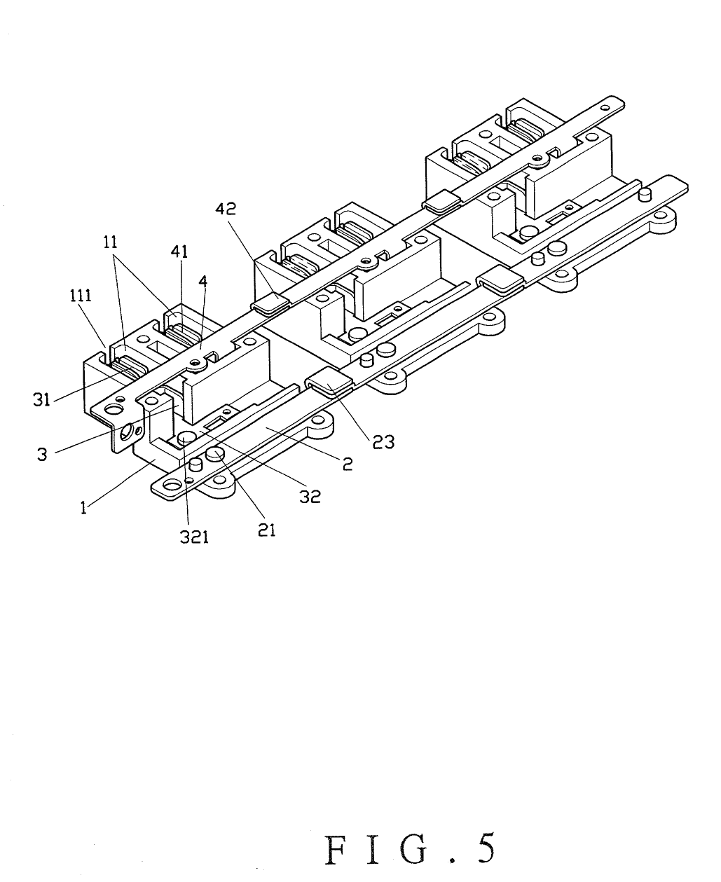

1. As shown in FIG. 5, take at least two identical single receptacles with the first conducting plates 2 and the third conducting plates 4 connected at their clippers 23 and 42 in series. By following the above process, each single receptacle may have similar peripheral devices, such as the switch device 6, the light indicator 7 to form as multiple electric power control series receptacle.

2. Both of the slot 31 of the second conducting plate 3 and the slot 41 of the third conducting plate 4 extends a portion, which form multiple slots 31 and 41 for multiple plugs to use. Peripherals may be installed at the beginning of the receptacle, so that the receptacle has a single switch device 6 and a single light indicator 7.

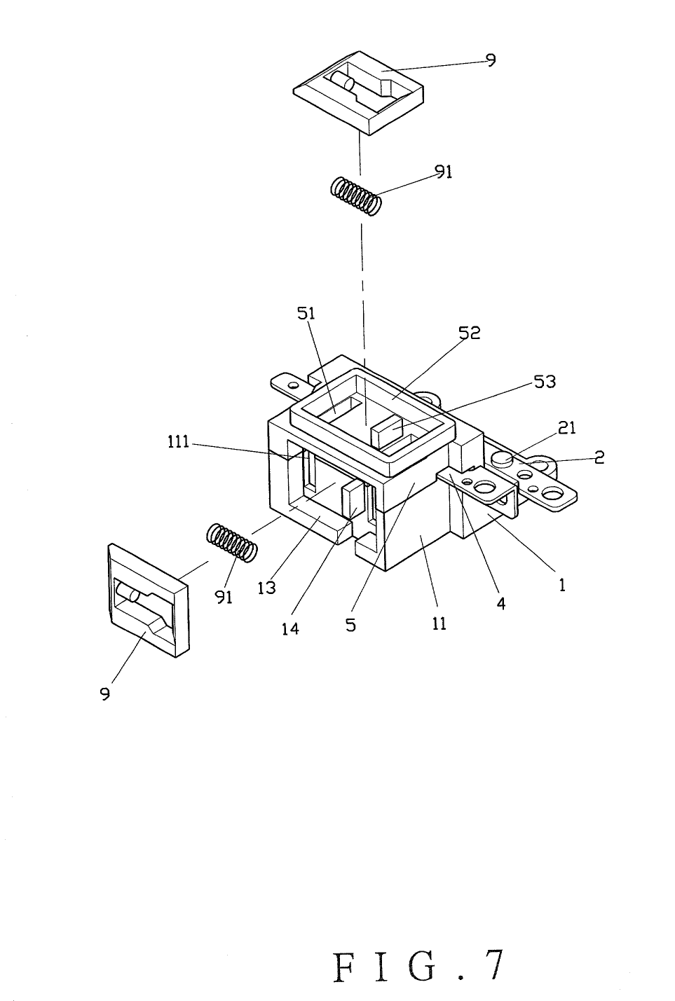

As shown in FIG. 7, the base 1 has a cover 5 with an edge 52 popped out, which then and a rib 13 of the base 1 is formed a receiving section for a cover 9 to mount thereat. Both the edge 52 and the rib 13 have blocks 53 and 14 adapted to engage with a spring 91 thereat, respectively.

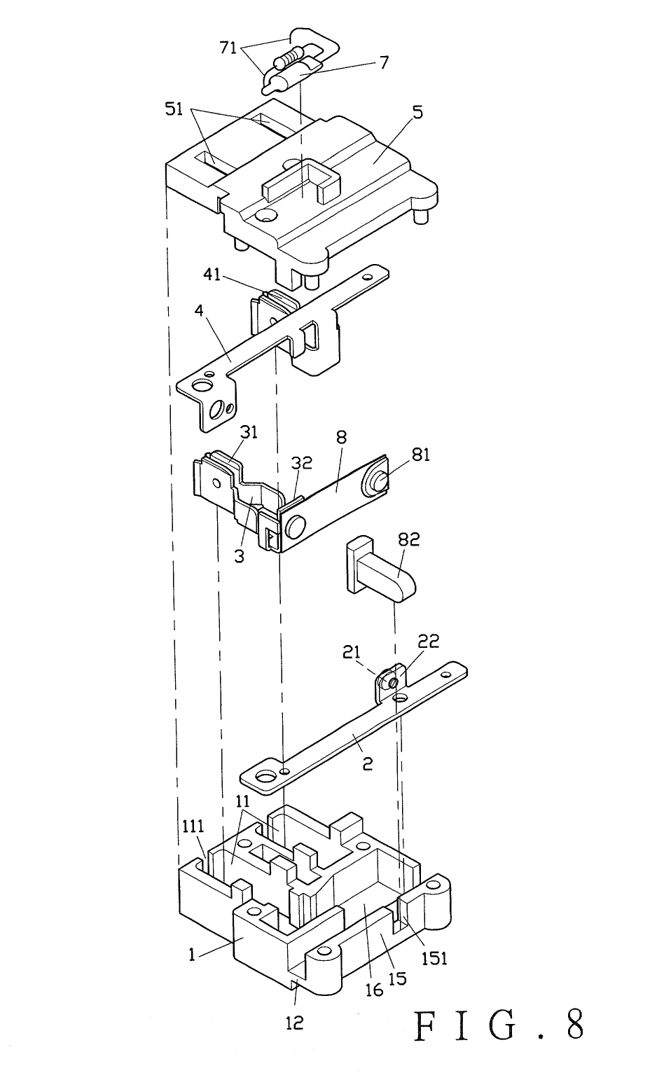

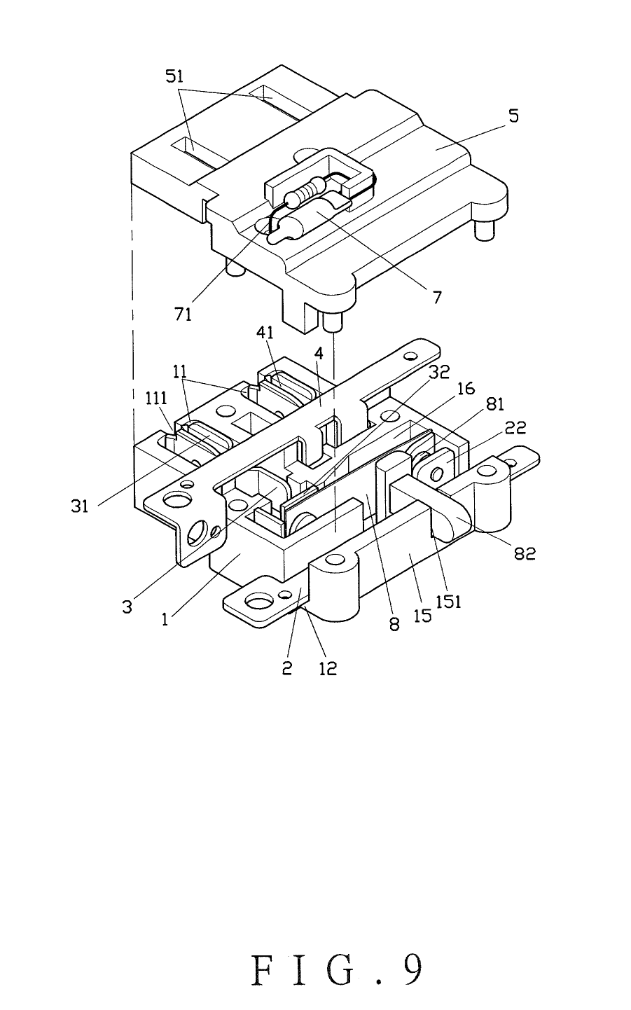

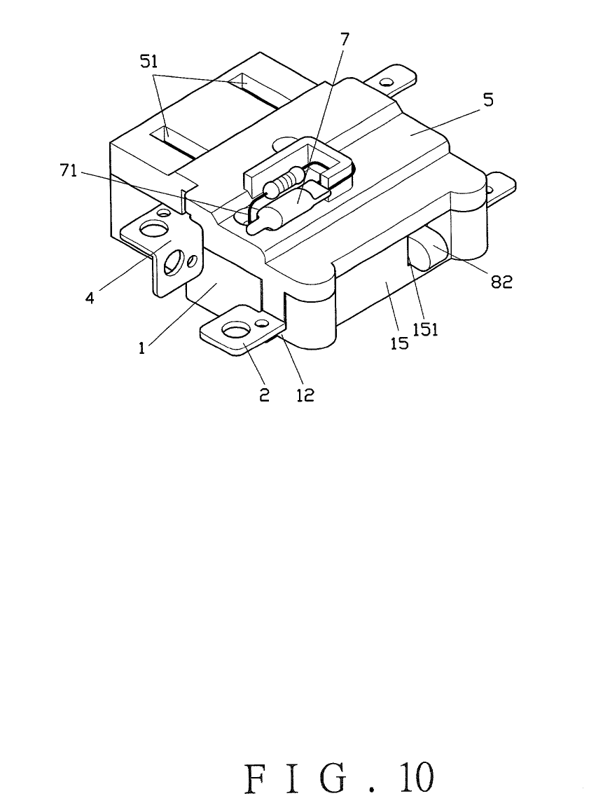

The shapes of the base 1 and the cover 5 may change at anytime, such as FIG. 8. The first conducting plate 2, the second conducting plate 3 and the third conducting plate 4 are wrapped in the base 1 with the cover 5. The base 1 has a block 15 with a notch 151 thereat and a trough 16. The light indicator 7 is placed on the top of the cover 5 with the two feet 71 extending downwardly. The first conducting plate 2 and the second conducting plate 3 may change their shape, such as the first conducting plate 2 extends a contact end 22 with a contact point 21 opposing with the contact end 32 of the conducting plate 3. Both of the contact ends 22 and 32 are in vertical position. The contact end 32 of the second conducting plate 3 is connected with one end of a conducting part 8 which has a contact point 81 engages in constant with the contact point 21 of the contact end 22 of the first conducting plate 2. Other then connecting with the first conducting plate 2, the conducting part 8 may be linked by a linkage 82 to movement in reciprocal and engaging or disengaging with the contact ends 22 and 32. In this manner, as shown in FIG. 9, the conducting part 8 is secured in the trough 16 between the bridge 12 and the trough 11, that separates the first conducting plate 2 and the second conducting plate 3 at respective ends. The linkage 82 stays on the notch 151 of the block 15 above the bridge 12 with its inner end engaging with the conducting part 8, while the outer end extending outwardly. As shown in FIG. 10, the light indicator 7 is secured on the top of the cover 5 with the two feet 71 extending downward and in connection with the second conducting plate 3 and the third conducting plate 4, thus the light indicator 7 turns on and off with the movement of the linkage 82.

I claim:

1. A receptacle with contact points for switch comprising:
a base with a trough defining two sections, and extending a portion from one side to form a bridge;
a longitudinal first conducting plate secured on said bridge of said base;
a longitudinal second conducting plate secured in one of said sections of said base, having a slot at one end and a contact end at the other end;
a longitudinal third conducting plate being also secured in another section and comprising a slot;
thus, said sections of said base being adapted to receive said longitudinal second conducting plate and said longitudinal third conducting plate therein, respectively, and forming a section to receive power plugs, said longitudinal second conducting plate in said trough having extending a contact end adjacent to said longitudinal first conducting plate, said contact end of said longitudinal first conducting plate engaging with said longitudinal second conducting plate through a conducting part.

2. The receptacle with contact points for switch, as recited ion claim 1, wherein a partition for said two sections in said trough is formed either integrally or by an insertion.

3. The receptacle with contact points for switch, as recited ion claim 1, wherein one side of said base corresponding to said longitudinal second conducting plate and said longitudinal third conducting plate in said trough is formed with holes, slots or open spaces for power plugs to use.

4. The receptacle with contact points for switch, as recited ion claim 1, wherein said slot of said longitudinal second conducting plate and said slot of said longitudinal third conducting plate have a various input method.

5. The receptacle with contact points for switch, as recited ion claim 1, wherein said contact end of said longitudinal second conducting plate and said longitudinal first conducting plate are formed with contact points, respectively.

6. The receptacle with contact points for switch, as recited ion claim 1, wherein an outer portion of said trough is popped out to form a receiving section for a cover to mount thereat.
